(19) United States
(12) Patent Application Publication
(10) Pub. No.: US 2019/0266983 A1
(43) Pub. Date: Aug. 29, 2019

(54) MayoStick

(71) Applicant: Wesley Ray Mayo, Merritt Island, FL (US)

(72) Inventor: Wesley Ray Mayo, Merritt Island, FL (US)

(21) Appl. No.: 16/266,792

(22) Filed: Feb. 4, 2019

Related U.S. Application Data
(60) Provisional application No. 62/709,946, filed on Feb. 5, 2018.

(51) Int. Cl. G10D 13/00; B25G 1/06; G10D 13/02

(52) U.S. Cl. CPC G10D 13/003; G10D 13/02; B25G 1/06

(57) ABSTRACT

The MayoStick a duo purpose Percussion/Drumstick, a truly duo-purpose stick, a drumstick designed for efficient and purposeful drumming. The MayoStick has an exotic hardwood solid shaft of 13 in length with a 3 in taper to a standard drumstick tip at one end, the other end a 3 in long bundle of rounded 4 mm bamboo. This can also be put in a form where having a solid center shaft of exotic hardwood at 10 in with a 3 in length bundle of rounded 4 mm bamboo at one end, the other end a 3 in bundle of 2.5 mm bamboo, this giving a total length of a 16 in percussion stick. Both versions give a performer multiple uses from one style of drumstick, this increases the abilities and efficiency of the percussionist.

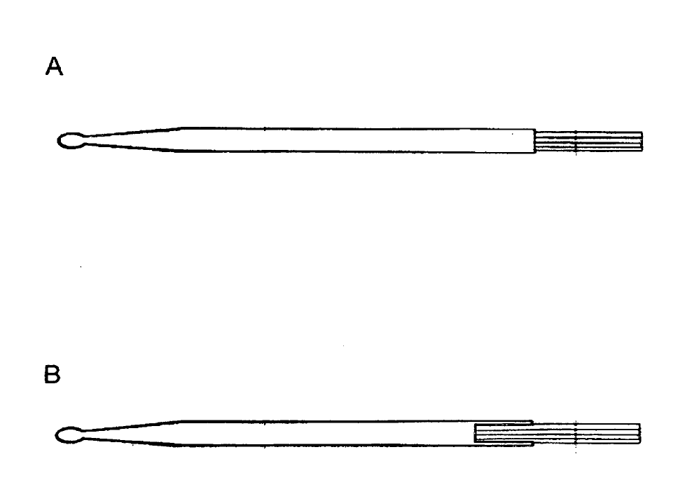

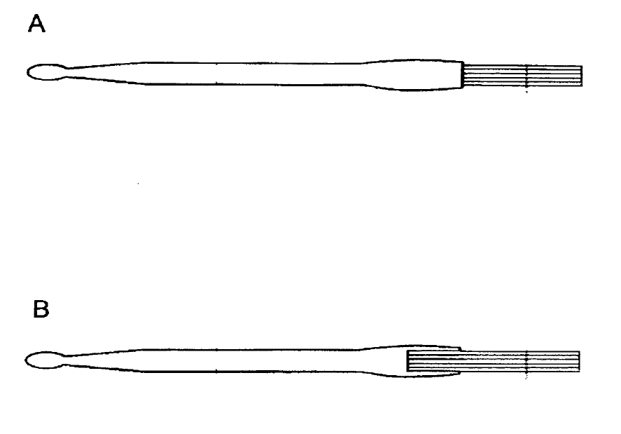

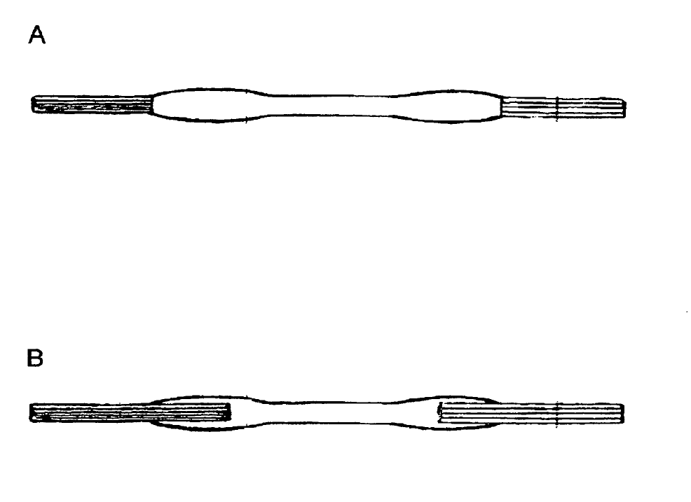

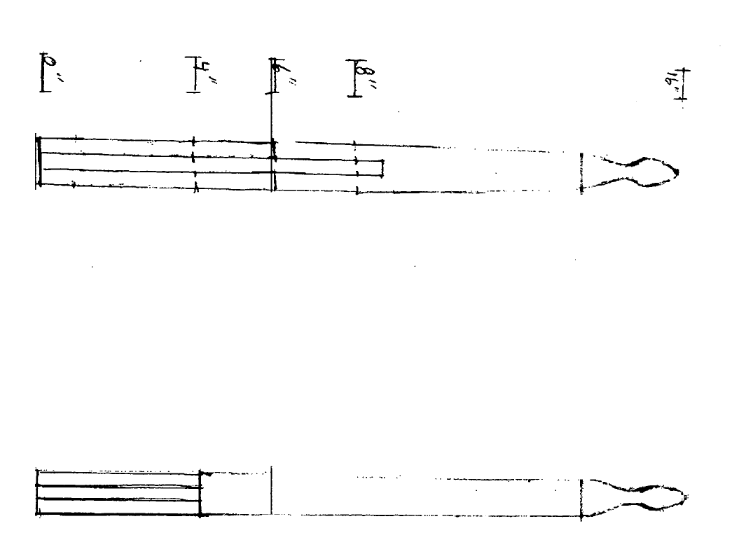

Page 1, A: This is the original standard MayoStick; A 13 in solid shaft of exotic hard wood with a 14.3 mm diameter, tapering at one end, this taper begins 3 in inward from the tip where it is carved into a standard percussion stick tip. The opposite end is cut flat and bored inward 40.64 mm with a 1.59 mm outer shell in order to encapsulate a bundle of rounded 4 mm bamboo pieces at 4.5 inches in length. This bamboo bundle extends 3 in past the end of the 13 in solid exotic hard wood shaft completing the MayoStick giving its full length of 16 in.

Page 1, B: This is the standard MayoStick shown sliced in half to give reference to diagram A.

Page 2, A: This is the same design as page 1, A. with a 14.3 mm diameter adding a convex shape to the bundle end which extends outward to a diameter of 17.43 mm at the center of the convex area, this is for use as a hand placement for a better fulcrum usage to the solid tip end of the percussion stick. This also gives a stronger more durable encasement around the bamboo bundle end.

Page 2, B: this diagram shows the MayoStick sliced in half showing its full design.

Page 3, A: this is the MayoStick with both ends of the solid exotic wood shaft bored inward at 40.64 mm each end is designed with a convex shape for handling and strength. The solid shaft is 10 Inches in length with each bamboo bundle extending outwards 3 in giving a full length of 16 in. The diameter at the center part of the shaft at 14.3 mm, 17.43 mm at the center of each convex handle end, the bundled bamboo is 4 mm at one end and 2.5 mm at the other end.

Page 3, B: this diagram shows the MayoStick sliced in half giving full view of the design.

The MayoStick is built from exotic hardwood for reason of strength and tone quality, the depth of the bore has been calculated for consistency in strength to the bundle. The Bundle is made of bamboo for its durability and by using an adhesive it stays together both with itself and to the hardwood shaft. The simplicity of this stick makes it a useful affordable way to enhance any player's abilities.

### Purpose

Mayo Stick reason: My reason to construct this type of beater came from necessity I needed a drum stick for practice purposes that would have the ability to have 2 distinct different tone values. My life is busy so my practice time at home was not adequate enough T needed a set of drum sticks that could produce the standard solid stick tone, also emulate the tone of a hihat. The brush style of percussion sticks had a similar tone so joining these 2 styles is the answer.

The Mayo Sticks abilities were becoming more apparent to me during the development. It gave me a better understanding tone time frame with in a song by having the ability to separate the tone factors without the need of a full drum kit. For as a drummer has a need to change their style from the sharp tone of a solid stick to a softer brush tone within the beat of the music piece played the Mayo Stick can do this without having to change sticks allowing no interruptions with the ongoing song. These observations continued as the Mayo Stick evolved into its final stage, a durable, efficient, multipurpose percussion beater, I found that it had advanced my drumming abilities better then I imagined.

The Mayo Stick I have found through its design process is a vital tool for any percussionist or drummer. This style of stick allows the user a more efficient way to instantly change the tone, along with technique, and style to fit a piece of music without changing his style of stick. No need to replace one set of sticks to another when the next song requires it just a flick of the wrist, this is efficient in keeping the whole process of playing music more about the playing. The Mayo Stick gave me a more efficient way to learn new songs, it has helped me become a better drummer with my technique and a more varied style. The Mayo Stick is capable of enhancing technique and style to anyone that uses it.

### Description

Mayo Stick description: 16″ double ended drum stick/percussion beater, section 1 is a 12″ long solid piece of exotic hard wood doweling with a diameter range from 1.37 cm to 1.6 cm, section 2 is a bundle/brush style. This bundled section can vary in diameter size and quantity and is made of bamboo doweling and these can range from 7 to 10 pieces at 4″ in length with a diameter ranging from 3 mm to 5 mm.

The Mayo Stick construction for e design is as follows, each stick requires 1 12″ piece of exotic hard wood round doweling. Marking one end of the dowel as 1 and the other end as 2. I start at end 1 then Drill a center hole from one end of the doweling down 4″ with a ¼″ drill bit, next end 1 will be hollowed out to a depth of 2″ there will now be a perimeter wall at 1/16″ 2″ deep with a center hole at ¼″ that extends another 2″. Now 1 8″ 5 mm bamboo dowel will be inset in the center hole with a light coat of epoxy next the surrounding pieces will be inset into the 2″ space depending on the style 6 to 9 pieces of 6″ bamboo dowel at 3 to 5 mm will be coated with epoxy and set.

This now must be left 24 hours to dry, next the process of shaping the end 2 with a desired tip style and shaping of the solid piece of exotic hard wood. Once desired look is complete the stick will be coated with a wood hardener and teak and left to dry.

1. The MayoStick has been created for the need of a truly useful duo purpose Percussion/Drumstick. In looking for such a stick it was found that it did not exist, even in going to a patent library to see if such an item had ever been built. This is a duo purpose Drumstick that is viable in practice, rehearsal, and performing. For practice, it is useful in many ways, one in particular is; when practicing a song and not on a Drum Kit the need to understand the differences in the hitting a tom in comparison to a hi-hat or cymbal are very important when it comes to timing and understanding the human ears function in learning a song.
The MayoStick takes this in consideration by its duo purpose design, where one end can be used as a standard drum stick, the other end can be used as a complimentary part used for a hi-hat sound. This gives quicker understanding to the beat and construction of a musical piece for the Percussionist/Drummer. In performing and rehearsals the MayoSticks duo purpose abilities hands a larger range to the performer, both in style and efficiency for the latter the performer does not need to change their sticks with the change of beat or style of music just a flip of the wrist will keep the music on track and flowing.
Becoming a proficient Percussionist/Drummer practice is very important and in practice building the muscles of the hand and fingers are a must. The design of the MayoStick gives to this importance of muscle retention, by its ability to create a need to twirl the stick between the performer's fingers and hands. Known that stick twirling is a muscle building process in itself, the more one does this and the more proficient they become at twirling the stronger their fingers become and the more comfortable and efficient drummer they become. This is a natural use with the MayoStick by its design.
